(19) United States
(12) Patent Application Publication
(10) Pub. No.: US 2005/0195913 A1
(43) Pub. Date: Sep. 8, 2005

(54) Communications system, method and device

(75) Inventor: Darren Phillip McNamara, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Toshiba, Tokyo (JP)

(21) Appl. No.: 11/062,840

(22) Filed: Feb. 23, 2005

(30) Foreign Application Priority Data
Feb. 27, 2004 (GB) 0404451.7

(51) Int. Cl. H04L 1/02

(52) U.S. Cl. 375/267

(57) ABSTRACT

A communications system (101) comprises a transmitting device (102) and a receiving device (114). The transmitting device (102) comprises at least T transmit antennas (116), means for spreading (110) each of T symbols (x) in the time domain only to produce T time sequences of chips (x₁, x₂, X₃=X) and transmitting the T time sequences of chips (X) from the T transmit antennas (116) respectively. The receiving device (114) comprises at least R receive antennas (118), means for despreading (120) the R time sequences of chips (y₁, y₂, y₃=Y) received from the transmitting device (102) at the R receive antennas (118) respectively to a produce R received symbols (z), and means for processing (116-1) the R received symbols (z) to produce an estimate (\hat{x}) of the T symbols (x) spread at the transmitting device (102).

This invention relates to a communications method for use in a communications system in which a transmitting device has a plurality of transmit antennas and a receiving device has a plurality of receive antennas. The invention also relates to a communications system and device using such a method. The invention has particular application where code and frequency division multiplexing schemes are applied to such a multiple-input multiple-output architecture.

A typical wireless network comprises a plurality of mobile terminals, each in radio communication with an access point or base station of the network. The access points are also in communication with a central controller that in turn may have a link to other networks, for example a fixed Ethernet-type network. Until recently considerable effort was put into designing systems so as to mitigate for the perceived detrimental effects of multipath propagation, especially prevalent in wireless LAN (local area network) and other mobile communications environments. However the described work G. J. Foschini and M. J. Gans, “On limits of wireless communications in a fading environment when using multiple antennas” Wireless Personal Communications vol. 6, no. 3, pp. 311-335, 1998 has shown that by utilising multiple antenna architectures at both the transmitter and receiver, a so-called multiple-input multiple-output (MIMO) architecture, vastly increased channel capacities are possible. Attention has also turned to the adoption of space-time coding techniques for wideband channels. Typically channel state information (CSI) for detection of such coding is acquired via training sequences and the resulting CSI estimates are then fed to a space-time decoder along with the received signal.

A particular problem arises in a communications link where a transmitter with more than one transmit antenna is employed, since signals received from different transmit antennas interfere with one another. This results in so-called multi-stream interference (MSI) and causes decoding difficulties. The potential advantage, however, is greatly increased throughput (that is, a higher bit rate) for such a communications link. In this type of MIMO (Multiple-input Multiple-output) communication link the “input” (to a matrix channel) is provided by the transmitter's plurality of transmit antennas and the “output” (from a matrix channel) is provided by a plurality of receive antennas. Thus each receive antenna receives a combination of signals from all the transmitter's transmit antennas which must be unscrambled.

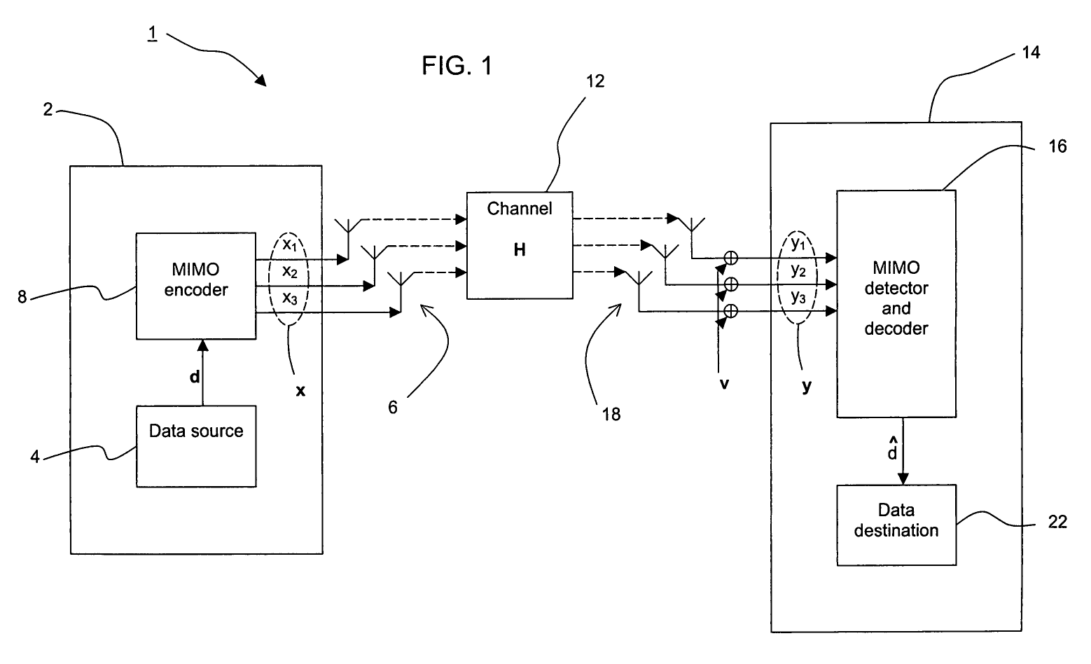

FIG. 1 of the accompanying drawings is a schematic diagram illustrating a typical MIMO communication system 1 comprising a transmitting device 2 and a receiving device 14. In the transmitting device 2, a data source 4 provides an information symbol vector d to a MIMO encoder 8 which encodes the symbol vector d as T code symbols x₁ x₂ . . . , x_{T}. The T code symbols x₁ x₂ . . . , x_{T} can be represented as transmit symbol vector x, and in this example, T is three. The T code symbols x₁ x₂ . . . , x_{T} are then transmitted separately and simultaneously from T transmit antennas 6 respectively. An example of a MIMO encoder 8 is found by a direct mapping of input symbol dᵢ to output symbol xᵢ.

In the receiving device 14, a plurality R of receive antennas 18 receives respectively signals y₁, . . . . y_{R}, represented as symbol vector y. For a narrowband channel the channel conditions of the channel 12 between the transmitting device 2 and the receiving device 14 is represented by an R×T channel response matrix H (having R rows and T columns), with the noise contribution at the receiver being represented by the R-dimension noise vector v. Using this model,
y=Hx+v. (1)

The receive signals y are then input to a MIMO detector and decoder 16, along with an estimate of the channel response matrix, H. Channel estimation in the MIMO detector 16 can be achieved in a number of well-documented ways. These inputs to the MIMO detector 16 can be used to form an estimate \hat{x} of the transmit symbol vector, or to directly form an estimate of the information symbol vector d. An example MIMO detector 16 corresponding to the example encoder described above is to generate a linear estimator matrix W equal to H⁻¹, so that the estimate \hat{x} of the transmit symbol vector is given by:
\hat{x}=Wy. (2)
This estimate \hat{x} of the transmit symbol vector is then decoded by the MIMO decoder 16 by performing the reverse of the encoding operation performed by the MIMO encoder 8 to produce an estimate \hat{d} of the original information symbol vector d, and this estimate \hat{d} is passed to the data destination 22.

In the example above, the linear estimator matrix W effectively separates the plurality of transmitted signals arriving at the receive array. Non-linear equalisers are more optimal and may employ maximum likelihood (ML) or maximum a posteriori probability (MAP) estimation techniques.

In the above example, data transmission over the channel 12 from multiple users can be handled using time division multiplexing in combination with the spatial multiplexing of MIMO so that the sequence of operations above is performed in one time frame for one user and for another user in the next time frame.

When the channel is frequency selective, this can be handled by using the OFDM (Orthogonal Frequency Division Multiplexing) technique. With standard OFDM there are a number (say, N) of overlapping tones (or sub-carriers). The bit stream is split into N parallel data streams at a rate of 1/N of the original rate. Each stream is modulated onto a unique tone and then combined to a single signal for transmission from a single antenna by means of an N-point inverse Fast Fourier Transform (IFFT). The tones are orthogonal with adjacent ones and so do not interfere. Each block of N samples output from the IFFT is known as an OFDM symbol. A fixed number of additional samples are copied from the end of each OFDM symbol and pre-pended to it. This is known as a cyclic prefix (CP). Because this CP is designed to be longer than the greatest delay of the multipath channel response, inter symbol interference (ISI) is eliminated and the data on each sub-carrier experiences a narrowband flat fading channel response.

A combined MIMO-OFDM system would operate similarly to the basic OFDM system described above where the system model for each sub-carrier can be expressed using equation (1) above. For each sub-carrier a different symbol vector, x, would be transmitted, a different signal vector, y, would be received, and a different channel response matrix, H, would be experienced. For example, if there were N sub-carriers, N MIMO-encoded transmit vectors would be generated. The N symbols corresponding to the first transmit antenna would be input to an IFFT and an OFDM symbol for the first transmit antenna created. This process would be repeated for each transmit antenna. The resultant T OFDM symbols would then be transmitted simultaneously over the multiple antennas of the MIMO system.

Third generation mobile phone networks use a form of multiplexing known as CDMA (Code Division Multiple Access) spread spectrum signals for communicating across the radio interface between a mobile station and a base station. These 3G networks are encompassed by the International Mobile Telecommunications IMT-2000 standard. Collectively the radio access portion of a 3G network is referred to as UTRAN (Universal Terrestrial Radio Access Network) and a network comprising UTRAN access networks is known as a UMTS (Universal Mobile Telecommunications System) network. The UMTS system is the subject of standards produced by the Third Generation Partnership Project (3GPP, 3GPP2), technical specifications for which can be found at www.3gpp.org. Fourth generation networks, although not yet defined, may employ MIMO-based techniques.

Multi-Carrier Code Division Multiple Access (MC-CDMA) is similar to OFDM, but data symbols are first spread as for CDMA with a spreading code having a spreading factor SF (representing the number of chips per data bit). Multiple users can therefore be supported by each user employing a different spreading code. The SF chips are then allocated to SF adjacent sub-carriers of an OFDM system, i.e. with no spreading in time. This can result in the loss of orthogonality between spreading codes at a receiver, as each sub-carrier experiences a different channel gain. However, the use of a suitable CP, as for ordinary OFDM, eliminates inter symbol interference (ISI).

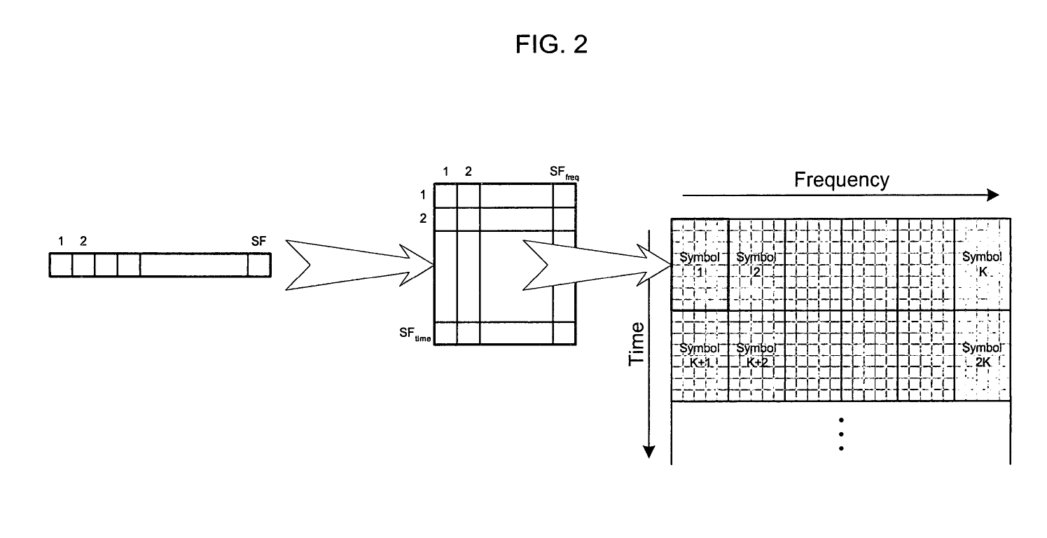

Orthogonal Frequency Code Division Multiplexing (OFCDM) is similar to MC-CDMA, but the chips resulting from spreading a single symbol can be arranged in blocks of frequency and time, so that each data symbol is allocated to a number of sub-carriers and a number of OFDM symbols on those sub-carriers. The dimensions of the block can be altered, for example the spreading can be SF in time and 1 in frequency, or vice versa, or some other combination making up SF chips. This is illustrated in FIG. 2 of the accompanying drawings. In the example of FIG. 2, the overall spreading factor SF illustrated in the left-most portion is allocated with a spreading factor SFₜᵢₘₑ in the time domain and SF_{freq} in the frequency domain, as illustrated in the middle portion of FIG. 2. As illustrated in the right-most portion of FIG. 2, the chips of the first symbol (Symbol 1) of user data are allocated across the first SF_{freq} subcarriers and the first SFₜᵢₘₑ OFDM symbols. The next symbol (Symbol 2) of user data is spread and allocated in a similar way, being allocated to the next SF_{freq} subcarriers and the same SFₜᵢₘₑ OFDM symbols. This is repeated until all the subcarriers are filled with the user's data (with Symbol K occupying the final SF_{freq} subcarriers). The SFₜᵢₘₑ OFDM symbols can then be transmitted, and the next SFₜᵢₘₑ OFDM symbols can then be allocated and transmitted in the same way. Thus a single user data fills all subcarriers (N/SF_{freq} must be an integer, in this example equal to K). In the right-most portion of FIG. 2, the allocation is schematically shown as SF_{freq}=5 and SFₜᵢₘₑ=8 by the grid division illustrated within each symbol. MC-CDMA can be described as an OFCDM system where symbols are always spread by a factor of SF in frequency and 1 in time.

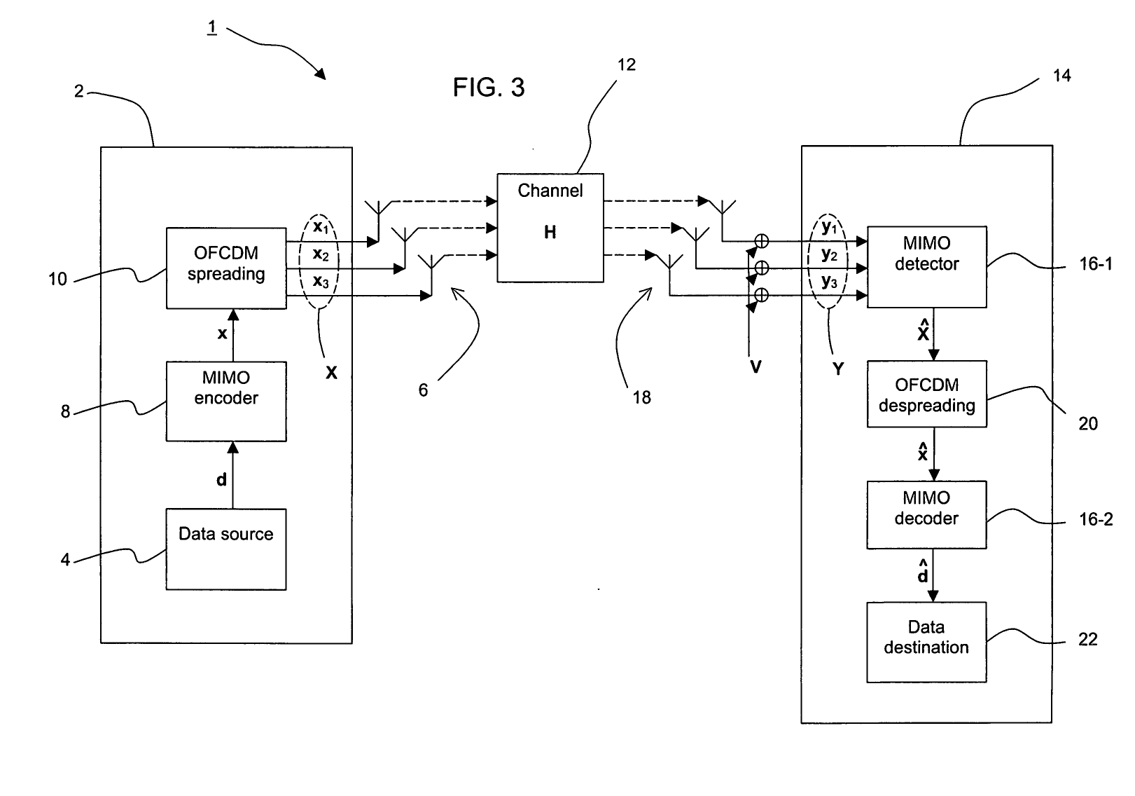

FIG. 3 of the accompanying drawings shows how the MIMO communication system 1 of FIG. 1 can be modified to enable data from multiple users to be multiplexed according to the OFCDM scheme. To simplify the explanation, only the data from a single user will be illustrated; the data from other users is spread in frequency and time in a corresponding way and combined onto the same transmit signals described below.

As for the MIMO system of FIG. 1, in the transmitting device, a data source 4 provides an information symbol vector d to a MIMO encoder 8 which encodes the symbol vector d to a T-dimensional symbol vector x. Unlike in the MIMO system of FIG. 1, in the MIMO-OFCDM system of FIG. 3, the symbol vector x is then processed by an OFCDM spreading portion 10 before transmission. The symbol vector x is spread in time to give a T×SFₜᵢₘₑ transmit chip matrix X (T rows and SFₜᵢₘₑ columns), where SFₜᵢₘₑ is the spreading factor in the time dimension. The transmit chip matrix X is also spread across SF_{freq} adjacent frequency sub-carriers as described above and the various sub-carriers combined before transmission over the T transmit antennas 6.

The response of the channel 12 between the transmitting device 2 and the receiving device 14, for a single sub-carrier, is again represented by a R×T channel response matrix H (R rows and T columns), with the noise contribution now being represented by a R×SFₜᵢₘₑ matrix V.

Using the above channel model, the R×SFₜᵢₘₑ chip matrix Y received at the receiving device 14, can be represented as:
Y=HX+V.

The received signals Y are then input to a MIMO detector 16-1. As before, the MIMO detector 16-1 requires an estimate of the channel response matrix, H, which can be obtained using methods well known to someone skilled in the art. An example MIMO detector 16-1 is to generate a linear estimator matrix W equal to H⁻¹ so that the estimate \hat{X} of the transmit chip matrix is given by:
\hat{X}=WY.

This is performed separately for each sub-carrier. The estimates \hat{X} of the transmit chip matrix for each sub-carrier are then passed to an OFCDM despreading portion 20 which performs the reverse of the spreading performed by the OFCDM spreading portion 10, resulting in an estimate \hat{x} of the T-dimension symbol vector x. This estimate is then decoded by the MIMO decoder 16-2 by performing the reverse of the encoding operation performed by the MIMO encoder 8 to produce an estimate \hat{d} of the original data symbol vector d, and this estimate \hat{d} is passed to the data destination 22.

As described above, the receiving device 14 conducts its antenna processing (channel estimation) separately on each sub-carrier, before despreading. This results in two principle disadvantages.

Firstly, the signal transmitted on each sub-carrier will contain the summation of chips from multiple users' symbols. Thus the effective constellation is no longer that for a single symbol, but rather a composite constellation derived from the summation of multiple chips (symbols scaled by +1 or −1 in the case of binary spreading sequences), one for each user, vastly increasing the number of points. For many practical implementations this limits the MIMO detector 16-1 to using only linear processing, such as the above matrix W, or the MMSE (Minimum Mean Square Error) solution. In particular, this precludes the use of the optimal A Posteriori Probability (APP) detector due to the vast number of possible solutions that must be searched.

Secondly, since Y is composed effectively of SFₜᵢₘₑ time-sequential vectors of chips, the detector 16-1 must perform SFₜᵢₘₑ estimation operations when calculating \hat{X}=WY in order to estimate a single symbol from each transmit antenna. This is a significant overhead, greatly increasing the amount of computations for the receiving device 14.

In “Broadband Packet Wireless Access Based on VSF-OFCDM and MC/DS-CDMA”, H. Atarashi, N. Maeda, A. Abeta and M. Sawahashi, in Proc. PIMRC, Lisbon, September, 2002, there is proposed a broadband packet wireless access employing Variable Spreading Factor-Orthogonal Frequency and Code Division Multiplexing (VSF-OFCDM) with two-dimensional spreading that prioritizes time domain spreading in the forward link and Multi-carrier/DS-CDMA (MC/DS-CDMA) in the reverse link for the system beyond IMT-2000.

In “Antenna Diversity Reception Appropriate for MMSE Combining in Frequency Domain for Forward Link OFCDM Packet Wireless Access”, N. Maeda, H. Atarashi, S.

Abeta and M. Sawahashi, IEICE Trans. Commun., Vol. E85-B, No. 10, October, 2002, pp. 1966-1977 there is presented an antenna diversity combining method associated with despreading that employs Minimum Mean Square Error (MMSE) combining over the frequency domain in a frequency-selective fading channel for forward link Orthogonal Frequency and Code Division Multiplexing (OFCDM) wireless access, in order to improve radio link capacity. This reference demonstrates the concept of antenna processing either before or after the despreading operation.

It is desirable to provide a system that overcomes some or all of the above disadvantages.

According to a first aspect of the present invention there is provided a communications method for use in a communications system comprising a transmitting device having at least T transmit antennas and a receiving device having at least R receive antennas, the method comprising: spreading each of T symbols in the time domain only to produce T time sequences of chips; transmitting the T time sequences of chips from the T transmit antennas respectively of the transmitting device; despreading each of R time sequences of chips received from the transmitting device at the R receive antennas of the receiving device respectively to produce R received symbols; processing the R received symbols to produce an estimate of the T symbols spread at the transmitting device.

The T symbols are preferably each spread and the R time sequences of chips are preferably each despread based on the same user-specific spreading code, with each user of the communications system being allocated a different spreading code. The spreading codes allocated to each user are preferably orthogonal spreading codes.

The T time sequences of chips may be modulated onto a sub-carrier prior to transmission The sub-carrier may be a sub-carrier in an Orthogonal Frequency Division Multiplexing scheme.

The communications system may be a Multiple Input Multiple Output, MIMO, system. The R received symbols may be processed using a MIMO detector. The T symbols may be MIMO-encoded symbols produced by a MIMO encoder for transmission from the T transmit antennas.

The R received symbols may be processed in order to estimate the T symbols spread at the transmitting device using non-linear estimation techniques, such as the A Posteriori Probability technique. Or the R received symbols may be processed in order to estimate the T symbols spread at the transmitting device using linear estimation techniques.

According to a second aspect of the present invention there is provided a communications system comprising: a transmitting device comprising at least T transmit antennas, and means for spreading each of T symbols in the time domain only to produce T time sequences of chips, and transmitting the T time sequences of chips from the T transmit antennas respectively; and a receiving device comprising at least R receive antennas, means for despreading each of R time sequences of chips received from the transmitting device at the R receive antennas respectively to produce R received symbols; and means for processing the R received symbols to produce an estimate of the T symbols spread at the transmitting device.

According to a third aspect of the present invention there is provided a communications method for use by a receiving device having at least R receive antennas in a communications system further comprising a transmitting device having at least T transmit antennas and operable to spread each of T symbols in the time domain only to produce T time sequences of chips and to transmit the T time sequences of chips from the T transmit antennas respectively, the method comprising: despreading each of R time sequences of chips received from the transmitting device at the R receive antennas of the receiving device respectively to produce R received symbols; processing the R received symbols to produce an estimate of the T symbols spread at the transmitting device.

According to a fourth aspect of the present invention there is provided communications device for use in a communications system comprising a transmitting device having at least T transmit antennas and operable to spread each of T symbols in the time domain only to produce T time sequences of chips and to transmit the T time sequences of chips from the T transmit antennas respectively, the communications device comprising: at least R receive antennas, means for despreading each of R time sequences of chips received from the transmitting device at the R receive antennas of the receiving device respectively to produce R received symbols; and means for processing the R received symbols to produce an estimate of the T symbols spread at the transmitting device.

According to a fifth aspect of the present invention there is provided an operating program which, when run on a communications device, causes the device to carry out a method according to the third aspect of the present invention.

According to a sixth aspect of the present invention there is provided an operating program which, when loaded into a communications device, causes the device to become one according to the fourth aspect of the present invention.

The operating program may be carried on a carrier medium, which may be a transmission medium or a storage medium.

Reference will now be made, by way of example, to the accompanying drawings, in which:

FIG. 1, discussed hereinbefore, is a schematic diagram illustrating a typical MIMO communication system;

FIG. 2, also discussed hereinbefore, is a schematic illustration of the arrangement of spread chips in blocks of frequency and time in the Orthogonal Frequency Code Division Multiplexing (OFCDM) scheme;

FIG. 3, also discussed hereinbefore, is a schematic diagram illustrating the MIMO communication system of FIG. 1 adapted to the OFCDM scheme;

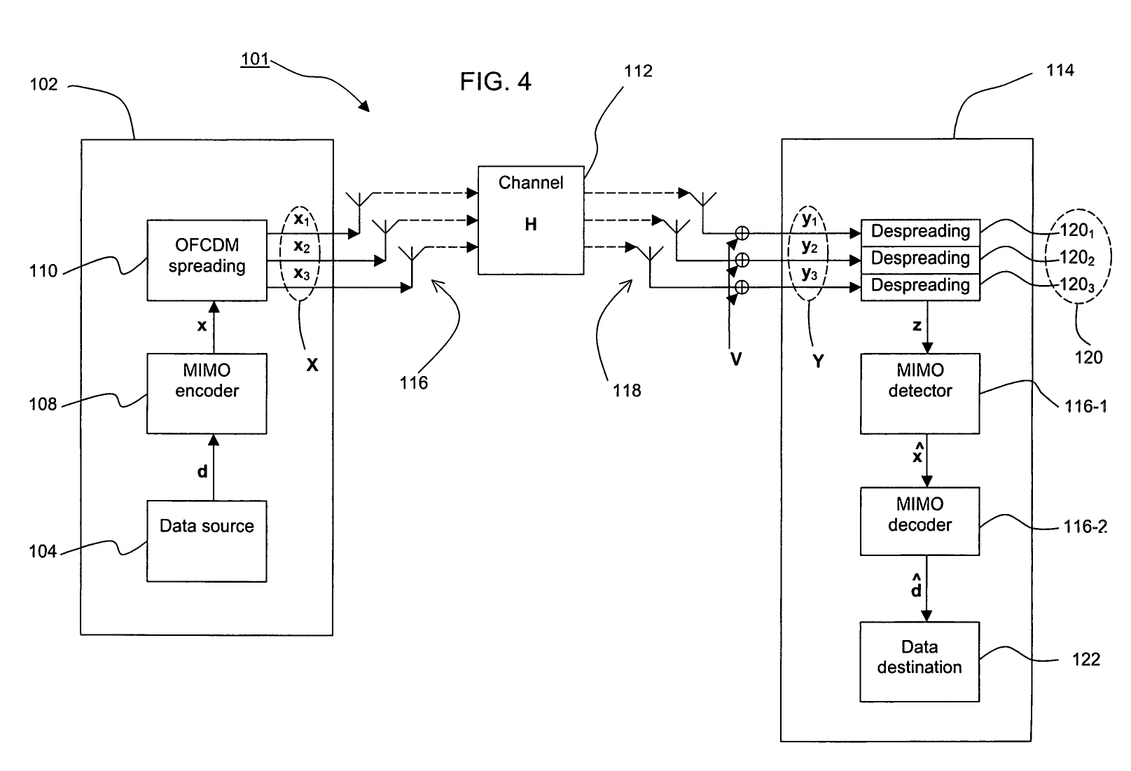

FIG. 4 is a block diagram illustrating a communications system according to an embodiment of the present invention; and

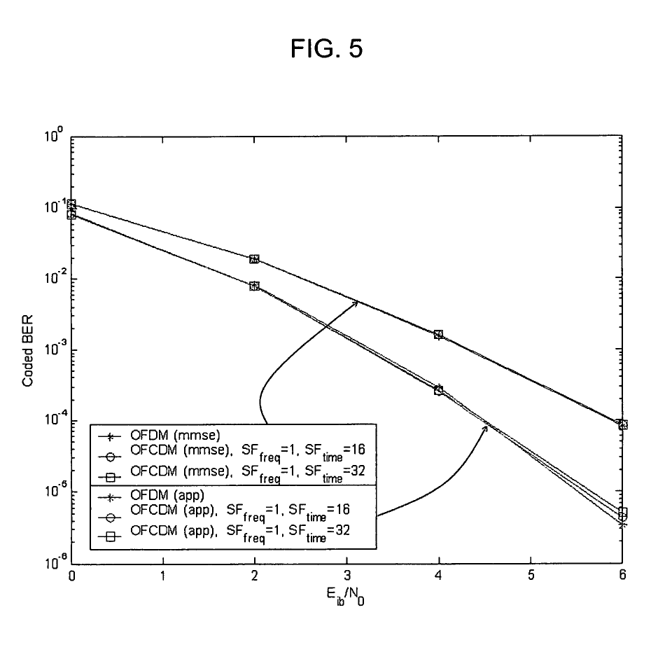

FIG. 5 is a chart providing a performance comparison of an embodiment of the present invention with an Orthogonal Frequency Division Multiplexing (OFDM) scheme.

FIG. 4 is a block diagram illustrating a communications system 101 according to an embodiment of the present invention. The communications system 101 embodying the present invention is similar in some respects to the communications system 1 described above with reference to FIG. 3, but there are significant differences which will be described below.

The communications system 101 embodying the present invention comprises a transmitting device 102 and a receiving device 114. The communications system 101 is based on the MIMO architecture, so that the transmitting device 102 comprises a plurality T of transmit antennas and the receiving device comprises a plurality R of receive antennas 118. In the illustration shown in FIG. 4, T and R are both three.

In the transmitting device 102, a data source 104 provides an information symbol vector d to a MIMO encoder 108 which encodes the symbol vector d as T code symbols x₁ x₂ . . . , x_{T}, which are represented as the symbol vector x.

In a similar way as described above with reference to FIG. 3, the symbol vector x is then processed by an OFCDM spreading portion 110 before transmission. Each of the T symbols in the symbol vector x is spread to a time sequence of chips, so that the symbol vector x is spread in time to produce a T×SF transmit chip matrix X (T rows and SF columns), where SF is the spreading factor in the time domain. The T symbols in the symbol vector x are each spread based on a spreading code, with each user of the communications system 101 being allocated a different, orthogonal, spreading code. In this embodiment the transmit chip matrix X is generated as:
X=xc
where c is a 1×SF spreading vector, where the entries are, for example, one of the orthogonal Walsh-Hadamard spreading codes of length SF.

Unlike for the system described above with reference to FIG. 3, in an embodiment of the present invention there is no spreading in the frequency domain. The T time sequences of chips contained in the transmit chip matrix X are separately modulated onto the first sub-carrier prior to transmission separately from the T respective transmit antennas 116. This is repeated, with a different transmit chip matrices, X, being modulated onto each of the remaining sub-carriers. All sub-carriers are then combined and transmitted simultaneously. In this embodiment, the sub-carriers are sub-carriers in an Orthogonal Frequency Division Multiplex (OFDM) scheme. Therefore, at the transmitting device 102 at least, the communications system 101 operates according to a MIMO OFCDM scheme, but with spreading only in the time domain.

Restriction to spreading in the time domain but not in the frequency domain leads to several advantages that will be described in more detail below. In the analysis presented below, only a single sub-carrier will be considered; each of the other sub-carriers is treated in an analogous manner.

In this embodiment, the channel response of the channel 112 between the transmitting device 2 and the receiving device 14 is represented by a R×T channel response matrix H (R rows and T columns), with the noise contribution being represented by a R×SF matrix V. Using this channel model, the R×SF chip matrix Y received at the receiving device 114 by the R receive antennas 118 can be represented as:
Y=HX+V.

Using a scheme as proposed in the prior art described above with reference to FIG. 3, the received signals Y (effectively a matrix of R time sequences of chips) would then input to a MIMO detector 16-1 in order to descramble the MIMO channels and recover estimates of the chip sequences transmitted from the T transmit antennas 116. As before, the MIMO detector 16-1 also requires an estimate of the channel response matrix, H, which can be obtained using methods well known to someone skilled in the art. An example MIMO detector 16-1 is to generate a linear estimator matrix W equal to H⁻¹ so that the estimate \hat{X} of the transmit chip matrix in the prior art would be given by:
\hat{X}=WY.

The chip sequence estimate matrix \hat{X} would then be despread according to the prior art scheme, resulting in an estimate \hat{x} of the T-dimension symbol vector x as follows:
\hat{x}=\hat{X}c^{T}

This estimate \hat{x} would then be decoded in the prior art scheme by a MIMO decoder to produce an estimate \hat{d} of the original data symbol vector d.

Using the MIMO detection scheme of the prior art where the detection is performed on sequences of chips, this effectively means that the MIMO detection function is required to be called SF times, once for each of the SF R-dimensional chip vectors in the received chip matrix Y.

However, the restriction imposed above that in an embodiment of the present invention there is spreading only in the time domain and not in the frequency domain allows a different scheme to be used at the receiving device 114. A further assumption is made that the channel response does not change over the duration of the transmission of the time sequences of SF chips. For the majority of applications, neither the above restriction nor the above assumption will present a problem.

Since the initial restriction and assumption in the communications system 101 embodying the present invention ensure that orthogonality between spreading codes will always be maintained, there is no need for chip equalisation, and the received signals can be directly despread. This will not be affected by the number of users that are code-multiplexed, with the signals from individual users being treated independently.

Therefore, in an embodiment of the present invention the R chip sequences in the chip matrix Y are passed to R separate despreading portions 120₁ 120₂, . . . 120_{R}. Despreading in this manner results in an R-dimensional vector z of symbols, rather than chips, as follows:
z=Yc^{T}

The R symbols in the symbol vector z are then passed to the MIMO detector 116-1 to produce an estimate of the T data symbols in the symbol vector x transmitted from the transmit antennas 116. An example MIMO detector 116-1 is to generate a linear estimator matrix W equal to H⁻¹ so that the estimate \hat{x} of the transmit symbol vector is given as:
\hat{x}=Wz.

It can readily be seen that performing MIMO detection at symbol level, after despreading, only requires the MIMO detection function to be called once, rather than SF times as in the prior art. This is apparent by a comparison of the operation \hat{X}=WY required in the prior art with the operation \hat{x}=Wz required in this embodiment of the present invention. In the former, the chip matrix Y being operated on by the linear estimator W is made up of a SF vectors of dimension R (chip-level detection), whereas in the latter the symbol vector z is made up of only a single vector of dimension R (symbol-level detection). Thus the number of MIMO detection operations has been reduced by a factor of SF with an embodiment of the present invention; in a typical application SF may be 16, 32, 64 or more, so the decrease in required processing can be significant.

The symbol-level processing scheme embodying the present invention will be of increasing bcncfit as the number of antennas in the system increases. For these larger dimensional systems the antenna processing requirements at the receiving device can quickly become substantial or prohibitive, so a reduction in complexity of SF times will be all the more important.

Another important advantage over the prior art is that, since the MIMO detector 116-1 in an embodiment of the present invention is estimating symbols as opposed to chips, the MIMO detection process is no longer limited to the use of linear estimators as mentioned above in respect of the prior art system. Non-linear detectors such as the optimal A Posteriori Probability (APP) detector could be applied to the symbol vector z in order to obtain a better estimate of \hat{x}, and this can lead to an improvement in performance.

Therefore, whilst the linear estimator W in the above-described embodiment serves as an example of a MIMO detector, this operation could (and probably would in practice) be replaced with another MIMO detector. Therefore, instead of the detection process in the above embodiment of the present invention being represented by:
\hat{x}=Wz
in the general case it would be represented by:
\hat{x}=f(z)
where \hat{x} is now some arbitrary function of z. This function could be a linear estimator such as W, or a successive interference cancellation detector such as the V-BLAST (Bell Labs Layered Space Time) algorithm, or an exhaustive search method such as the Maximum Likelihood (ML) or A Posteriori Probability (APP) detector. With such non-linear MIMO detectors, as mentioned above it is important whether the input is just the received signal (Y), i.e. a matrix of chips, or the despread signal (Yc^{T}), i.e. a vector of symbols. Processing the received signals according to an embodiment of the present invention allows any existing (or future) MIMO detection technique to be employed for OFCDM systems, as the output from the MIMO detection function will be in the form of symbols and not chips.

Since orthogonality between the spreading codes is ensured in the above embodiment of the present invention, the performance of a fully-loaded MIMO OFCDM system embodying the present invention (i.e. spreading in the time domain only) should be identical to that of an equivalent MIMO OFDM system (i.e. without spreading at all).

Such a performance comparison is provided in FIG. 5 for a communications system having two transmit and two receive antennas. The vertical axis denotes the Bit Error Rate (BER) when employing an outer convolutional code, and the horizontal axis denotes the ratio of energy per information bit to noise variance. The graph comprises two groups of lines, with each group of lines comprising three closely-spaced but separate lines. For the first group, apparent in FIG. 5 as the higher of the two, a MMSE detector was used, while for the second group, apparent as the lower of the two, an APP detector was used. The three separate lines represent the results where: (i) an OFDM system was used; (ii) an OFCDM system was used with SF=16; and (iii) an OFCDM system with SF=32 was used. For the OFCDM systems the number of code-multiplexed users equals the total spreading factor SF.

From the wide separation between the two groups it is apparent that the APP detector provides superior performance. From the close separation between the lines within a group, it is apparent that very similar performance is provided from an OFDM system as compared to an OFCDM system embodying the present invention for spreading factors SF of 16 and 32 (in the time domain).

Whilst a practical implementation of the chip-level scheme according to the prior art may only be able to implement the MMSE solution, the symbol-level processing scheme according to an embodiment of the present invention could use the APP detector instead in order to obtain the improved performance apparent from FIG. 5. The results shown in FIG. 5 are only for the symbol-level processing scheme, but the curves for chip-level processing with MMSE detection would be identical to the MMSE curves shown in FIG. 5.

It will be appreciated that operation of one or both of the transmitting device 102 and receiving device 114 can be controlled by a program operating on the device. Such an operating program can be stored on a computer-readable medium, or could, for example, be embodied in a signal such as a downloadable data signal provided from an Internet website. The appended claims are to be interpreted as covering an operating program by itself, or as a record on a carrier, or as a signal, or in any other form.

An embodiment of the present invention can be applied to any communications system employing MIMO OFCDM, for example a mobile phone or base station in a mobile telecommunications system, or an access point or terminal in a wireless Local Area Network.

1. A communications method for use in a communications system comprising a transmitting device having at least T transmit antennas and a receiving device having at least R receive antennas, the method comprising:
spreading each of T symbols in the time domain only to produce T time sequences of chips;
transmitting the T time sequences of chips from the T transmit antennas respectively of the transmitting device;
despreading each of R time sequences of chips received from the transmitting device at the R receive antennas of the receiving device respectively to produce R received symbols;
processing the R received symbols to produce an estimate of the T symbols spread at the transmitting device.

2. A communications method as claimed in claim 1, wherein the T symbols are each spread and the R time sequences of chips are each despread based on the same user-specific spreading code, with each user of the communications system being allocated a different spreading code.

3. A communications method as claimed in claim 2, wherein the spreading codes allocated to each user are orthogonal spreading codes.

4. A communications method as claimed in claim 1, 2 or 3, wherein the T time sequences of chips are modulated onto a sub-carrier prior to transmission.

5. A communications method as claimed in claim 4, wherein the sub-carrier is a sub-carrier in an Orthogonal Frequency Division Multiplexing scheme.

6. A communications method as claimed in any preceding claim, wherein the communications system is a Multiple Input Multiple Output, MIMO, system.

7. A communications method as claimed in claim 6, wherein the R received symbols are processed using a MIMO detector.

8. A communications method as claimed in claim 6 or 7, wherein the T symbols are MIMO-encoded symbols produced by a MIMO encoder for transmission from the T transmit antennas.

9. A communications method as claimed in any preceding claim, wherein the R received symbols are processed using non-linear estimation techniques.

10. A communications method as claimed in claim 9, wherein the R received symbols are processed using the A Posteriori Probability technique.

11. A communications method as claimed in any one of claims 1 to 8, wherein the R received symbols are processed using linear estimation techniques.

12. A communications system comprising:
a transmitting device comprising at least T transmit antennas, and means for spreading each of T symbols in the time domain only to produce T time sequences of chips, and transmitting the T time sequences of chips from the T transmit antennas respectively;
and a receiving device comprising at least R receive antennas, means for despreading each of R time sequences of chips received from the transmitting device at the R receive antennas respectively to produce R received symbols; and means for processing the R received symbols to produce an estimate of the T symbols spread at the transmitting device.

13. A communications method for use by a receiving device having at least R receive antennas in a communications system further comprising a transmitting device having at least T transmit antennas and operable to spread each of T symbols in the time domain only to produce T time sequences of chips and to transmit the T time sequences of chips from the T transmit antennas respectively, the method comprising:
despreading each of R time sequences of chips received from the transmitting device at the R receive antennas of the receiving device respectively to produce R received symbols;
processing the R received symbols to produce an estimate of the T symbols spread at the transmitting device.

14. A communications device for use in a communications system comprising a transmitting device having at least T transmit antennas and operable to spread each of T symbols in the time domain only to produce T time sequences of chips and to transmit the T time sequences of chips from the T transmit antennas respectively, the communications device comprising:
at least R receive antennas, means for despreading each of R time sequences of chips received from the transmitting device at the R receive antennas of the receiving device respectively to produce R received symbols; and means for processing the R received symbols to produce an estimate of the T symbols spread at the transmitting device.

15. An operating program which, when run on a communications device, causes the device to carry out a method as claimed in claim 13.

16. An operating program which, when loaded into a communications device, causes the device to become one as claimed in claim 14.

17. An operating program as claimed in claim 15 or 16, carried on a carrier medium.

18. An operating program as claimed in claim 17, wherein the carrier medium is a transmission medium.

19. An operating program as claimed in claim 17, wherein the carrier medium is a storage medium.
